(19) United States
(12) Patent Application Publication
(10) Pub. No.: US 2007/0102617 A1
(43) Pub. Date: May 10, 2007

(54) Powertrain mount

(75) Inventors: Todd Wirges, Ann Arbor, MI (US); Donald Price, New Hudson, MI (US); Phung Le, Sterling Heights, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 10/567,145

(22) PCT Filed: Aug. 6, 2004
(86) PCT No.: PCT/US04/25505

§ 371 Date: Sep. 11, 2006

Related U.S. Application Data
(60) Provisional application No. 60/492,918, filed on Aug. 6, 2003.

(51) Int. Cl. F16M 9/00

(52) U.S. Cl. 248/638

(57) ABSTRACT

A vibration isolation mount (10) is provided including a bracket member (12) including a base portion (18) having a pair of side wing portions (24, 26) extending from a pair of bends in the base portion (18). At least one pair of end wing portions (28, 30) extend from opposite ends of the bracket member (12). A core element (14) including a body portion (46) is disposed between the pair of side wing portions (24, 26). An elastomeric spring member (16) is disposed between the body portion of the core element (14) and the pair of side wing portions of the bracket member (12). The at least one pair of end wing portions (28, 30) are bent towards the elastomeric spring member (16) so as to oppose opposite ends of the spring member so as to provide a lateral travel restrictor for the elastomeric spring member (16) without the necessity of additional components. According to yet another aspect of the present invention, a travel restrictor pin (52) is provided extending between the pair of end wing portions (28, 30) and through an opening in the body portion (46) of the core element (14). The travel restrictor pin (52) provides additional longitudinal travel restriction in order to limit the amount of stresses applied to the elastomeric spring member (16).

### CROSS-REFERENCE TO RELATED APPLICATIONS

This application claims the benefit of U.S. Provisional Application No. 60/492,918, filed on Aug. 6, 2003. The disclosure of the above application is incorporated herein by reference.

### FIELD OF THE INVENTION

The present invention relates to a vibration isolation mount and more particularly, to an improved vibration isolation mount assembly and method of making.

### BACKGROUND OF THE INVENTION

Vibration isolation mounts are commonly used in automotive and non-automotive applications for reducing the transfer of vibrations from one member to another. In automotive applications, vibration isolation mounts are used between the vehicle body and frame as well as between the powertrain system or other components and the vehicle frame or body. In non-automotive applications vibration isolation mounts have been used in household appliances such as washers and dryers and have been used in industrial machinery. While vibration isolation mounts are effective at reducing vibrations, it is still desirable to provide a vibration isolation mount with a less complex assembly and manufacturing process.

### SUMMARY OF THE INVENTION

Accordingly, the present invention provides a vibration isolation mount having an improved construction in which the vibration isolation mount includes a bracket member including a base portion having a pair of side wing portions extending from a pair of bends in the base portion. At least one pair of end wing portions extend from opposite ends of the bracket member. A core element including a body portion is disposed between the pair of side wing portions. An elastomeric spring member is disposed between the body portion of the core element and the pair of side wing portions of the bracket member. The at least one pair of end wing portions are bent towards the elastomeric spring member so as to oppose opposite ends of the spring member so as to provide a travel restrictor for the elastomeric spring member without the necessity of additional components. According to yet another aspect of the present invention, a travel restrictor pin is provided extending between the pair of end wing portions and through an opening in the body portion of the core element. The travel restrictor pin provides additional travel restriction in order to limit the amount of stresses applied to the elastomeric spring member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a vibration isolation mount according to the principles of the present invention;

FIG. 2 is a front plan view of the vibration isolation mount shown in FIG. 1;

FIG. 3 is a perspective view of the bracket portion of the vibration isolation mount according to the principles of the present invention shown in the pre-assembled condition;

FIG. 4 is a perspective view of a vibration isolation mount according to a second embodiment in accordance with the principles of the present invention

FIG. 5 is end plan view of the vibration isolator mount shown in FIG. 4;

FIG. 6 is a perspective view of the vibration isolator mount of FIG. 4 shown in a partially assembled condition;

FIG. 7 is an end view of the partially assembled vibration isolator mount shown in FIG. 6;

FIG. 8 is a cross-sectional view of the vibration isolator mount shown in FIG. 6 and taken along line 8-8 of FIG. 6;

FIG. 9 is a cross-sectional view of a vibration isolator mount according to a third embodiment in accordance with the principles of the present invention;

FIG. 10 is an end view of the vibration isolator mount shown in FIG. 9; and,

FIG. 11 is a cross-sectional view taken along line 11-11 of FIG. 9.

### DETAILED DESCRIPTION OF THE PREFERRED EMBODIMENTS

The following description of the preferred embodiment(s) is merely exemplary in nature and is in no way intended to limit the invention, its application, or uses.

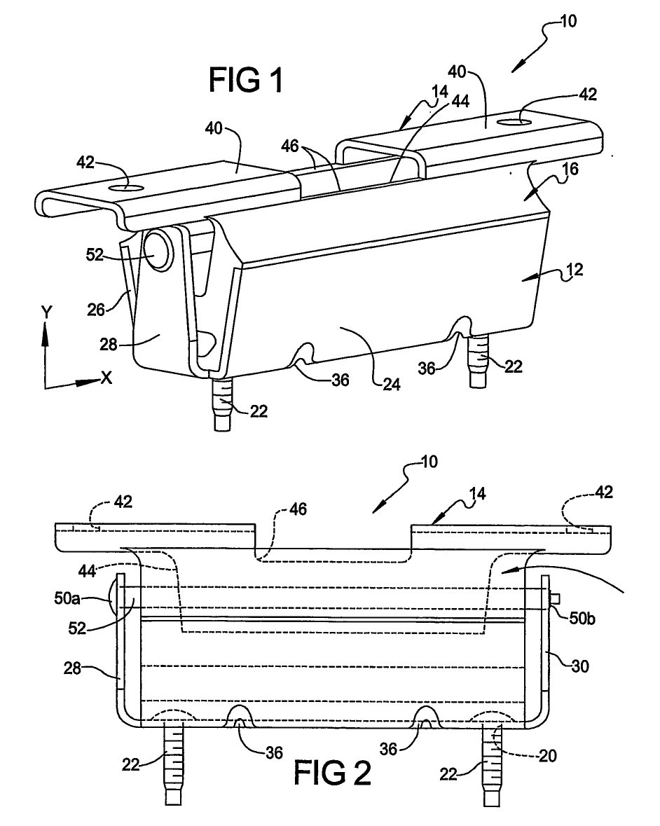

With reference to FIGS. 1-3, the vibration isolator mount 10 according to the principles of the present invention will now be described. The vibration isolator mount 10 includes a bracket portion 12 adapted to be mounted to a first support structure (not shown) and a core member 14 adapted to be mounted to a second support structure (not shown). An elastomeric spring member 16 is molded between the bracket 12 and core 14 in order to provide a spring member 16 for isolating vibrations between the bracket member 12 and the core member 14.

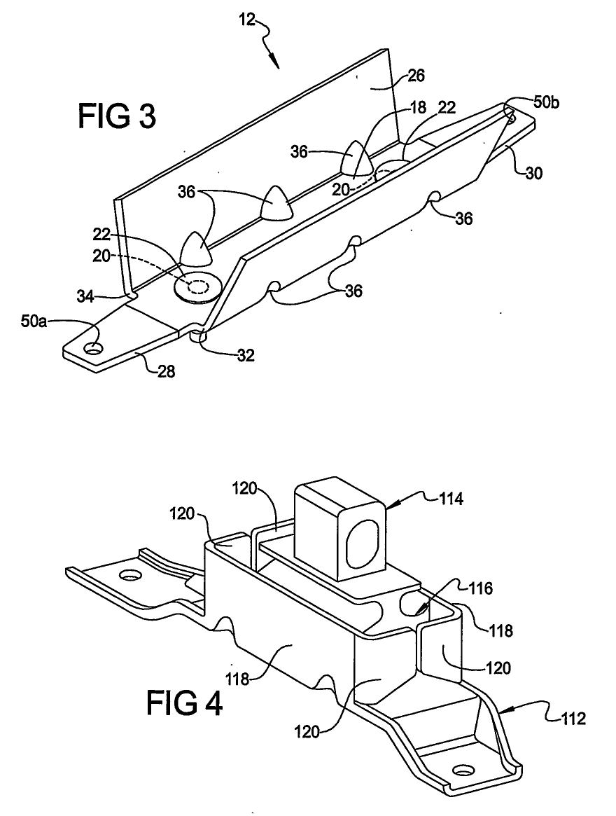

The bracket member 12 includes a base portion 18 having mounting apertures 20 therein adapted for receiving fasteners 22 therethrough for mounting the bracket 12 to a support structure. A pair of side wing portions 24, 26 extend from the base portion 18 and are in opposing relationship to one another. A pair of end wing members 28, 30 extend from the base portion 18. As illustrated in FIG. 3, the bracket member 12 is formed from a sheet metal as a stamping and the end wing portions 28, 30 are generally flat along with the base portion 18 prior to the final assembly of the vibration isolator mount 10. The side wings portion 24, 26 extend from the base portion 18 along bend portions 32, 34 which are each provided with strengthening ribs 36 formed therealong for strengthening the bend portions 32, 34 of the bracket member.

The core member 14 includes a mounting portion 40 provided with mounting apertures 42 for mounting the core member 14 to a second support structure (not shown). The core member 14 includes a body portion 44 including a pair of side walls 46 which form a U-shaped body extending between the side wing portions 24, 26 of the bracket member 12.

The elastomeric spring member 16 is molded in place between the bracket member 12 and core member 14. After the elastomeric spring member 16 is molded in place, the first and second end wing portions 28, 30 of the bracket member 12 are bent upward towards the elastomeric spring member providing a transverse travel restrictor in order to limit the amount that the elastomeric spring member can be stretched in either transverse direction. In addition, the first and second end wing portions 28, 30 are each provided with an aperture 50A, B which receives a restrictor pin 52 which extends through the U-shaped body 44 of the core member 14. The restrictor pin 52 serves as a travel restrictor for limiting the amount of travel of the core member 14 away from the bracket member 12 in a longitudinal direction as represented by the Y-axis shown in FIG. 1. With the construction of the present invention, the vibration isolator mount 10 has the ability to have a triaxially restricted powertrain mount without the addition of metal parts or fasteners. Furthermore, the present invention has the ability to have the triaxially restricted powertrain mount with as few as possible components. The vibration isolator mount also has low complexity and high manufacturing reliability. The design of the present invention also supports very light-weight designs due to minimal complexity and component use.

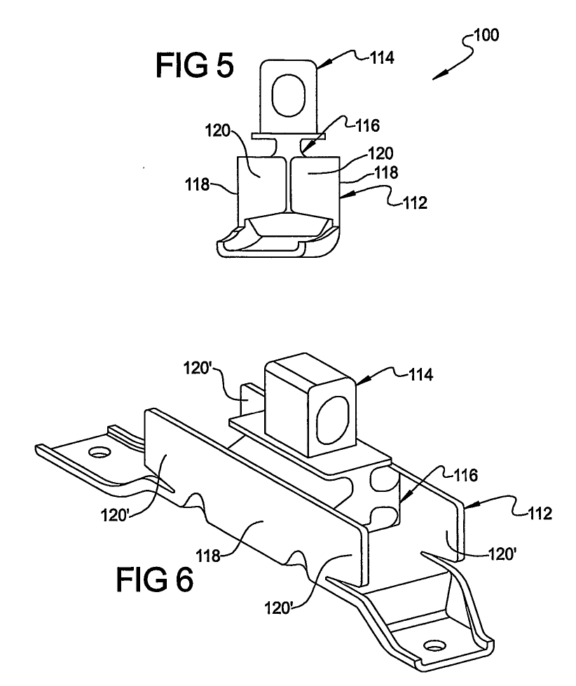

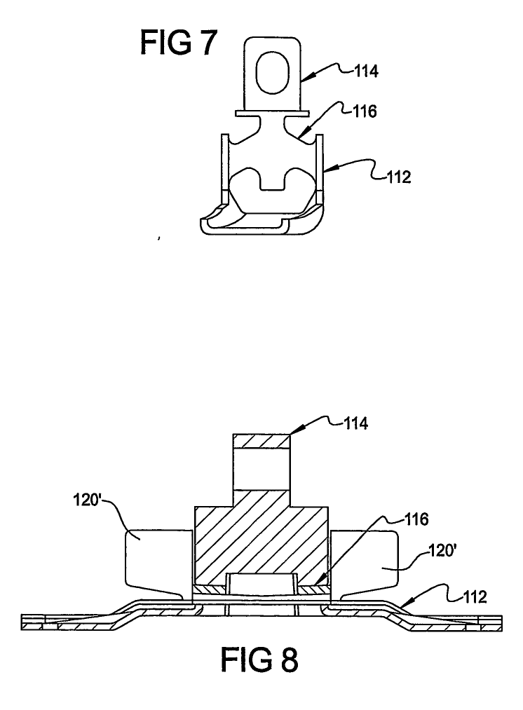

With reference to FIGS. 4-8, a vibration isolator mount 100 according to a second embodiment of the present invention will now be described. In the vibration isolator mount 100 as illustrated in FIGS. 4-8, the bracket member 112 and core member 114 are connected together by an elastomeric spring member 16 that is molded in place. The side wing portions 118 of the bracket member 112 are provided with a pair of end wing portions 120 which are bent inward toward the ends of the spring member 116. FIGS. 6-8 illustrate the four end wing portions 120 prior to being bent inward in the final assembly. FIGS. 6-8 illustrate the bracket 112 and core member 114 after the spring member 115 has been molded in place. The end wing portions 120 illustrate the end wings prior to being bent inward in a post-molding operation. The embodiment of FIGS. 4-8 is illustrative of how multiple end wing portions can be utilized on each end of the elastomeric spring member 116 for providing a travel restriction for restricting lateral travel of the core member 114 relative to the bracket member 112.

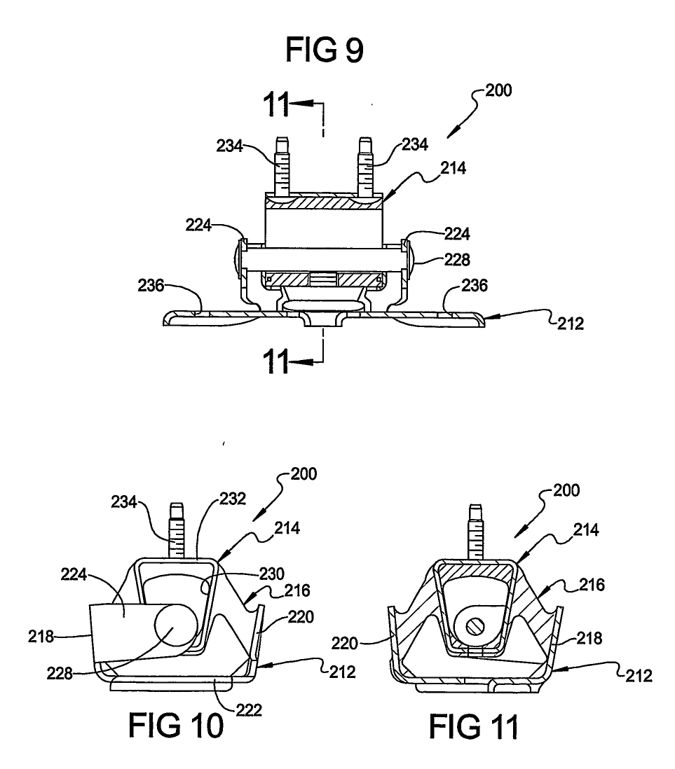

With reference to FIGS. 9-11, a vibration isolator mount 200 according to the principles of the present invention will now be described. The vibration isolator mount 200 is shown to include a bracket member 212 and core member 214 interconnected to one another by an elastomeric spring member 216 molded in place by bracket member 212 and core member 214. The bracket member 212 includes side wing portions 218, 220 extending from a base portion 220. Two end wing portions 224 extend from opposite ends of the side wing portion 218 and are bent inward in a post-molding operation to extend on opposite sides of the elastomeric spring member 216. A retainer pin 228 extends between the end wing portions 224 and through an opening 230 provided in the body portion of the core member 214. The core member 214 includes mounting fasteners 234 extending from the body portion 232 for mounting to a support structure. The bracket member 212 also includes mounting apertures 236 provided for mounting the bracket member 212 to a support structure.

The vibration isolator mount 200 shown in FIGS. 9-11 is illustrative of the ability to use end wing portions 224 extending from the side wing portions for providing lateral travel restriction for the core member 214 relative to the bracket member 212 and also supporting a restrictor pin 228 for providing longitudinal travel restriction between the core member 214 and the bracket member 212.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vibration isolator mount, comprising:
a bracket member including a base portion having a pair of side wing portions extending from a pair of bends in said base portion and at least one pair of end wing portions extending from opposite ends of at least one of said base portion and said pair of side wing portions;
a core element including a body portion disposed between said pair of side wing portions and a mounting portion attached to said body portion; and
an elastomeric spring member disposed between said body portion of said core element and said pair of side wing portions of said bracket member, said at least one pair of end wing portions being bent toward said elastomeric spring member so as to oppose opposite ends of said spring member.

2. The vibration isolator mount according to claim 1, wherein said at least one pair of end wing portions extend from opposite ends of said base portion of said bracket member.

3. The vibration isolator mount according to claim 1, wherein said at least one pair of end wing portions extend from opposite ends of one of said pair of side wing portions of said bracket member.

4. The vibration isolator mount according to claim 1, wherein said at least one pair of end wing portions includes two pairs of end wing portions with said two pairs of end wing portions extending from opposite ends of each of said pair of side wing portions of said bracket member.

5. The vibration isolator according to claim 1, wherein said at least one pair of end wing portions include a first end wing portion extending from an end of one of said pair of side wing portions of said bracket member and a second end wing portion extending from a second of said pair of side wing portions.

6. The vibration isolator according to claim 1, further comprising a travel restrictor pin extending between said at least one pair of end wing portions and through an opening in said body portion of said core element.

7. The vibration isolator according to claim 1, further comprising a travel restrictor member extending between said at least one pair of end wing portions and positioned to restrict travel of said core member relative to said base portion of said bracket member.

8. The vibration isolator according to claim 7, wherein said travel restrictor member includes a restrictor pin extending through an opening in said body portion of said core element.

9. The vibration isolator according to claim 8, wherein said travel restrictor pin extends through apertures in said at least one pair of end wing portions.

10. The vibration isolator according to claim 1, wherein said bracket member is formed from a stamped unitary metal plate.

11. The vibration isolator according to claim 1, wherein said bracket member includes at least one mounting aperture adapted for mounting said bracket member to a support structure.

12. The vibration isolator according to claim 1, wherein said mounting portion of said core element includes an aperture adapted for mounting said bracket member to a support structure.

13. The vibration isolator according to claim 1, wherein said pair of bends in said base portion of said bracket member each include strengthening ribs formed therein.

14. A vibration isolator mount, comprising:
a bracket member including a main body section having a pair of side wing portions opposing one another and at least one pair of end wing portions extending from opposite ends of said main body section;
a core element including a body portion disposed between said pair of side wing portions and a mounting portion attached to said body portion;
an elastomeric spring member disposed between said body portion of said core element and said pair of side wing portions of said bracket member, said at least one pair of end wing portions being bent toward said elastomeric spring member so as to oppose opposite ends of said spring member.

15. The vibration isolator mount according to claim 14, wherein said at least one pair of end wing portions extend from opposite ends of said base portion of said bracket member.

16. The vibration isolator mount according to claim 14, wherein said at least one pair of end wing portions extend from opposite ends of one of said pair of side wing portions of said bracket member.

17. The vibration isolator mount according to claim 14, further comprising a travel restrictor member extending between said at least one pair of end wing portions and positioned to restrict travel of said core member relative to said base portion of said bracket member

18. The vibration isolator according to claim 17, wherein said travel restrictor member includes a restrictor pin extending through an opening in said body portion of said core element.

19. The vibration isolator according to claim 18, wherein said travel restrictor pin extends through apertures in said at least one pair of end wing portions.

20. The vibration isolator according to claim 14, wherein said bracket member is formed from a stamped unitary metal plate.
